(19) United States
(12) Patent Application Publication
(10) Pub. No.: US 2011/0034159 A1
(43) Pub. Date: Feb. 10, 2011

(54) MOBILE DEVICE AUTO REDIALER

(76) Inventors: Earl W. PHILMON, Raleigh, NC (US); Sushil K. PRASAD, San Jose, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/538,820

(22) Filed: Aug. 10, 2009

(51) Int. Cl. H04M 3/00

(52) U.S. Cl. 455/418

(57) ABSTRACT

An automatic redialer for a mobile device operating in a cellular telecommunications environment. When a communication is terminated, the cause of termination is identified and, if the call was terminated due to a network or mobile telephone issue or failure, the automatic redialer will then proceed to redial the number associated with the dropped call either automatically, under certain conditions, or when instructed by a user of the mobile device. The automatic redialer operates to reconnect the call regardless of whether the call was an outgoing call originated from the user's mobile device or an incoming call wherein another party placed a call to the user's mobile device. In either case, the number can be retrieved from the mobile device, or in some cases even from the network, and a call can be re-established.

### BACKGROUND

The cellular telecommunications industry, which began to emerge into the market in the early 80's, has and continues to experience a large amount of growth both domestically and globally. Many factors may be contributed to the noteworthy success of the cellular telecommunications industry, including improvements in technology, reduction in size and cost of components, feature laden mobile devices converging with other portable device industries, etc. In addition, as the technology has migrated from AMPS, to NAMPS, to TDMA, to CDMA and beyond, the quality of service, coverage and reliability provided to the consumers has also improved—especially in markets where the adoption rate is high. However, the service isn't perfect and many users of cellular telecommunications experience a lack of service, poor quality of service and dropped calls—sometimes on a daily basis. As a result, it is a common scene to see someone speaking into a mobile telephone the universal phrase of cellular telephone users “can you hear me now?”

A frequent experience of mobile device users is that at unexpected times, and sometimes even at expected times, you will have dropped calls due to numerous network issues, electromagnetic radiation issues, multi-path, signal propagation issues and/or mobile device issues. Carriers work to improve their coverage or footprint but despite their best efforts, calls are dropped and connections are lost. One of the reasons can be attributed to the fact that the coverage topology of a cellular system design can change due to a variety of circumstances including, temperature, precipitation, traffic loads, etc. As such, almost everyone experiences dropped calls and then must either attempt to reinitiate the connection, wait on the other party to reinitiate the connection, or simply let it go. The experience can be frustrating to a customer, and in a business scenario, can even result in a loss of business. In addition, once a call or connection is dropped, it takes time to reinitiate and re-establish the connection and thus, the process disrupts the communications without warning, leaving both parties uncertain about what to do. In some situations, such as while the customer is driving a vehicle, it can be quite dangerous for the user to attempt to initiation the reestablishment of the connection.

While some carriers have deployed services that attempt to keep the call active over a connection even when the network connection fails, these services are not ubiquitous and available for all networks and service areas.

While there are some internal network technologies that can maintain a call even when the connection with the network has failed, those solutions are limited, not broadly deployed and cannot hold a call for an extended period of time. The network solution is only valuable for an extremely short timeframe because the user, once they realize they are no longer in communicative contact with the other party, will typically hang up or terminate the call and try to reinitiate the call.

Thus, despite the fact that the cellular industry has been working on this problem for nearly 30 years, calls are still dropped. And because we don't really know how much longer it will take to eradicate this problem, if it can actually every be eradicated, there is a need in the art for a technique to detect if a call has been dropped, and in response, attempt to reinitiate the call without any, or at least minimal user interaction.

Safety advocates have scrutinized mobile telephone and mobile device usage for quite awhile, especially use of the devices while operating a vehicle. Safety measures have been suggested such as hands-free dialing, hands-free operation, voice activated dialing, and the like. A primary concern of the safety advocates is that any diversion of the drive's eyes and attention from the task of operating the vehicle creates a risk to the driver, the passengers and those nearby. The safety advocates push for the use of hands free equipment, as well as other safety measures. When a call is dropped, if the user is operating a vehicle the user is obviously distracted from the task at hand if he or she attempts to reestablish the connection by redialing the number. Thus, there is a need in the art for a technique that detects when a call is dropped and then automatically attempts to reconnect the call.

With the introduction of smart telephone technology and the availability of application stores, many cellular telephone users now have the ability to download applications directly onto their mobile devices, thereby expanding the functionality and capabilities of the mobile devices. This technology provides an opportunity for a solution to the above-described problems that can be based within the cellular or mobile device itself, rather than the network or service provider equipment. This is advantageous because the millions of deployed mobile devices could then be modified or augmented to include such a solution.

These and other needs in the market are addressed by the various methods, apparatuses and systems that are presented in the remainder of this specification.

### BRIEF SUMMARY

The present disclosure presents an automatic redialer that attempts to reconnect dropped calls or other lost connections. The various embodiments presented herein generally operate to automatically detect when a call was dropped, versus an intentional disconnect, and will then proceed to redial the number associated with the dropped call either automatically, under certain conditions, or when instructed by a user of the mobile device. Some embodiments operate in a totally automatic mode rather than requiring the user to manually reconnect the call, or to look up and/or dial the number. The automatic redialer operates to reconnect the call regardless of whether the call was an outgoing call originated from the user's mobile device or an incoming call wherein another party placed a call to the user's mobile device. In either case, the number can be retrieved from the mobile device, or in some cases even from the network, and a call can be re-established.

One of the aspects of the various embodiments or implementations of the automatic redialer is the process of determining whether or not the call should be re-established. In some embodiments, this can be accomplished by evaluating the error information or other parameters associated with a call that has been ended. This information can be analyzed to determine if the call was ended purposefully or due to communication errors or failures. In many of today's smart cellular telephones and mobile devices, the error information is received from the network or generated by the device, stored within the device and available for applications operating on the device. By accessing and evaluating this information, the automatic redialer can make an accurate determination as to whether the call was indeed terminated due to network connectivity failure, or other causes.

In addition, the automatic redialer operates to monitor the network signal or connectivity to determine if and when to attempt to reestablish the call. This aspect of the various embodiments is based on the concept that there is little to no purpose in trying to reestablish a call until the network is available. So the automatic redialer monitors the network signal to determine when a new call can and should be initiated. In some embodiments, the automatic redialer is embedded entirely within the mobile device, whereas in other embodiments portions of the automatic redialer may exist external to the mobile device.

It will be appreciated that the user is only partially aided by an automatic redialer if the user must participate in any manner in reestablishing the call. For instance, even if the user has to watch for the reconnection to take place, the safety provided by the automatic redialer is diminished. Thus, embodiments of the automatic redialer can operate to provide an audio indication that the call is ready to be reconnected, thereby alerting the users that the call will begin shortly.

### BRIEF DESCRIPTION OF THE SEVERAL VIEWS OF THE DRAWING

FIG. 1 is a high-level flow diagram illustrating steps involved in an exemplary automatic redialer.

FIG. 2 is a functional block diagram of the components of an exemplary environment, such as a mobile device, suitable for various embodiments of the automatic redialer.

FIG. 3 is a flow diagram illustrating another embodiment of the automatic redialer operating within a mobile device.

FIG. 4 is a system diagram illustrating the relationship between two components engaged in a connection in which at least a portion of the connection is based on a cellular or mobile telephone network.

### DETAILED DESCRIPTION OF EMBODIMENTS OF THE INVENTION

The present disclosure presents various embodiments of an automatic redialer, as well as features and aspects thereof, that operate to detect failed cellular based calls or communications and automatically recover from the failure and reestablish the connection.

In general, one embodiment of the automatic redialer is targeted to provide a technique to re-establish telephone calls over a mobile network, or a cellular network that have been dropped. During a telephone call or any communications connection between two parties, multiple parties, a party and a call processing system (such as a bank or automated voice activated system) or a party and a telephone conference system, etc., if one or more of the links of the communications connection are over a cellular telephony network there is a risk that the communications connection can be fully or partially disabled due to a dropped call. If the telephone call is disconnected, this embodiment of the automatic redialer operates to determine the cause of the disconnection. If the cause of the disconnection is due to poor signal quality resulting in a dropped call, then a signal quality monitor process is started. If the signal monitoring process watches the current quality of the signal to identify a transition from poor quality to acceptable or good quality. Once the transition is identified, one or more attempts are then made to reestablish the telephone call. A notice is provided to inform the user that attempts to reestablish the telephone call are being made. The process to reestablish the telephone call can be accomplished in a variety of manners, and one such non-limit example is by automatically dialing the caller ID associated with the other end of the telephone call, whether it is a person or a device. Once the call is reestablished, normal call processing continues.

Many mobile devices provide the capability for uploading applications that can be stored within the mobile device and provide additional functionality not offered when the mobile device was first put into service. These applications are stored on the mobile device and are allowed to utilize the processor, memory and access APIs that control numerous functions including: screen changes, tones, errors reporting, call control, as well as other functions of the mobile device.

Now turning to the figures, various embodiments, features and aspects of the automatic redialer are presented in more detail.

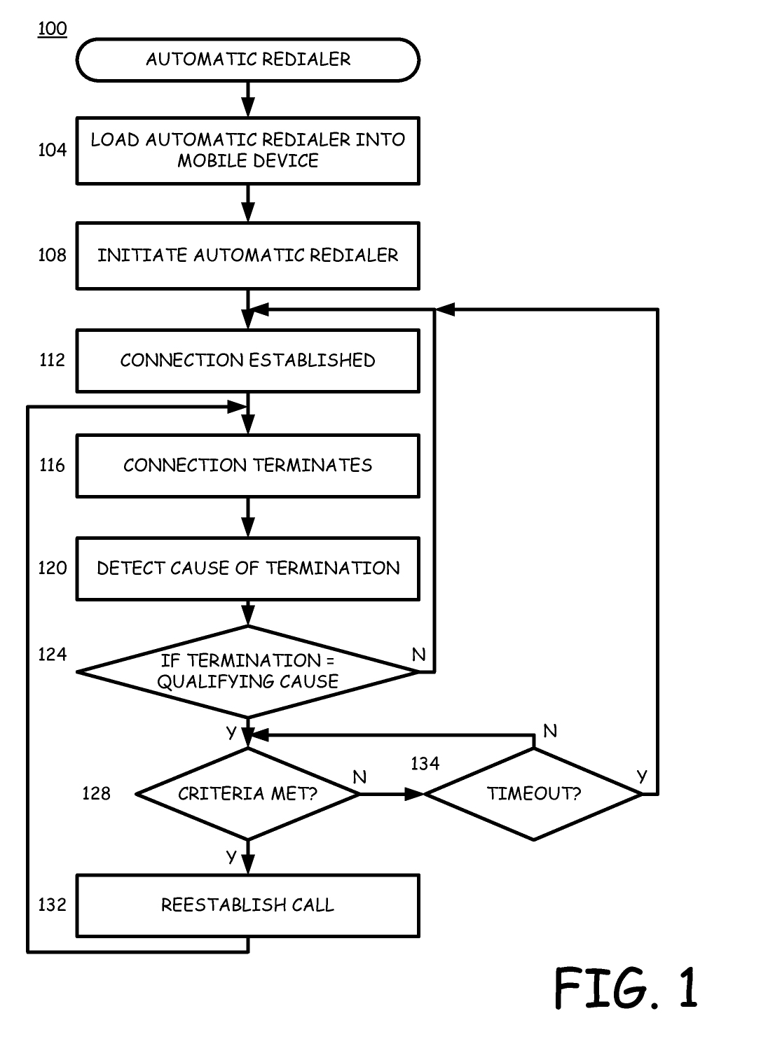

FIG. 1 is a high-level flow diagram illustrating steps involved in an exemplary automatic redialer. The automatic redialer 100 is first loaded into a mobile device 104. The mobile device may be any of a variety of devices including a mobile cellular telephone, a PDA, a smart phone, a portable computer, etc. In addition, the automatic redialer may be loaded into a non-mobile device such as a desktop computer, cellular base station equipment such as a personal communication system (PCS) or the like; however, for purposes of illustration, the automatic redialer will be described as being loaded into a mobile device. It should be appreciated that the automatic redialer may be an after-market or third-party type application that is loaded into the mobile device after the mobile device has been purchased or, the automatic redialer can be incorporated into the mobile device at the time of manufacture or when provisioning the mobile device.

The automatic redialer is then initiated while the mobile device is being operated 108. It should be appreciated that the automatic redialer may be automatically initiated as part of the powering on or booting cycle of the mobile device or, it may be user enabled once the mobile device is operational. Typically, the automatic redialer executes as a background process or a thread running under the control of the processing unit in the mobile device. In some embodiments, simply a shell or kernel may be initiated which in turn, may invoke the automatic redialer when needed. In addition or in the alternative, an interrupt scheme may be employed to trigger the initiation of the automatic redialer if certain criteria is met or detected.

The mobile device equipped with the automatic redialer can operate as normal for entering into communication connections. Thus, in any of the variety of embodiments, a connection can be established with the mobile device in several different manners 112. For instance, the connection can be established by a user initiating a telephone call to another number or, a call request being directed towards a telephone number associated with the mobile device. Likewise, the mobile device can receive a call from another telephone as it would without this application.

At some point in time, the connection is terminated 116. At this point, the automatic redialer operates to detect the cause of the termination 120. The automatic dialer attempts to determine if the cause of termination is a qualifying cause. For instance, if some embodiment, only a connection termination that is caused by poor signal quality may be classified as a qualifying cause. In other embodiments, all termination causes excluding a purposeful termination are classified as qualifying causes. For instance, a purposeful termination may include one of the parties pressing a button or taking other actions to cause the connection to terminate. As a specific non-limiting example, if the mobile device is an iPhone, a purposeful termination may include the user pressing the END CALL softkey, the hang-up button on a BLUETOOTH device, etc. As another example, a qualifying cause may exclude a connection that is terminated due to low battery strength.

If it is determined that the cause of termination is not a qualifying cause 124, then the process continues at step 112 where a next connection can be established. On the other hand, if the cause of termination is a qualifying cause 124, then the automatic redialer determines if criteria is met for attempting to reestablish the connection or call. In some embodiments, the criteria may simply be monitoring the signal quality to determine if the signal is sufficient for reestablishing the connection. In some embodiments this may simply be determining that the received signal strength satisfies a minimum power level. In other embodiments, a minimum signal strength must be established for a threshold period of time, such as 5-20 seconds as a non-limiting example. Other criteria may also be applied such as whether the call was originated or received by the user. For instance, in an exemplary embodiment, if the call was originated by the user, then the automatic redialer may attempt to reestablish the call 132. But, if the call was originated by someone or some device other than the user, then the connection may not be reestablished in some embodiments. In other embodiments, only “in-system” calls that would not invoke any charges against a user may meet the criteria for attempting to reestablish the call. In other embodiments, long distance calls may be excluded from satisfying the necessary criteria. Another criteria may be to ensure that the mobile device is not currently engaged in another call or in the process of setting up another connection. It should be appreciated that a variety of rules could be applied in different embodiments or a combination of the described rules and/or other rules may be implemented, or even no rules in some embodiments and the automatic redialer would attempt to establish the call in all circumstances.

If the automatic redialer determines that the criteria has been met 128, then the connection is reestablished 132 and processing continues at step 116 when the connection is again terminated. The process of reestablishing the connection can be accomplished in a variety of techniques. One technique is to simply dial the telephone number or caller ID number associated with the other end of the connection. In a cellular system, this step would include initiating a call setup command using the caller ID or the last number dialed depending on whether the connection was received by the user or originated by the user. It is also anticipated that in other embodiments, other system features or protocol features may also be employed in an attempt to reestablish the connection.

If the automatic redialer determines that the criteria has not been met 128, in some embodiments a timeout function 134 is used to provide a period of time for the criteria to be met. For instance, if the criteria includes waiting for the received signal strength to reach a minimal value or cross a specific threshold (i.e., 1 bar or a specific RSS value), the timeout function will allow a specific amount of time for this criteria to be met. If the criteria is not met within the timeout period, then processing can continue at step 112. As a non-limiting example, if the signal strength is insufficient to reestablish the connection for 2 minutes, then the automatic redialer will abort the process and no attempts to reestablish the connection will be made after that period of time.

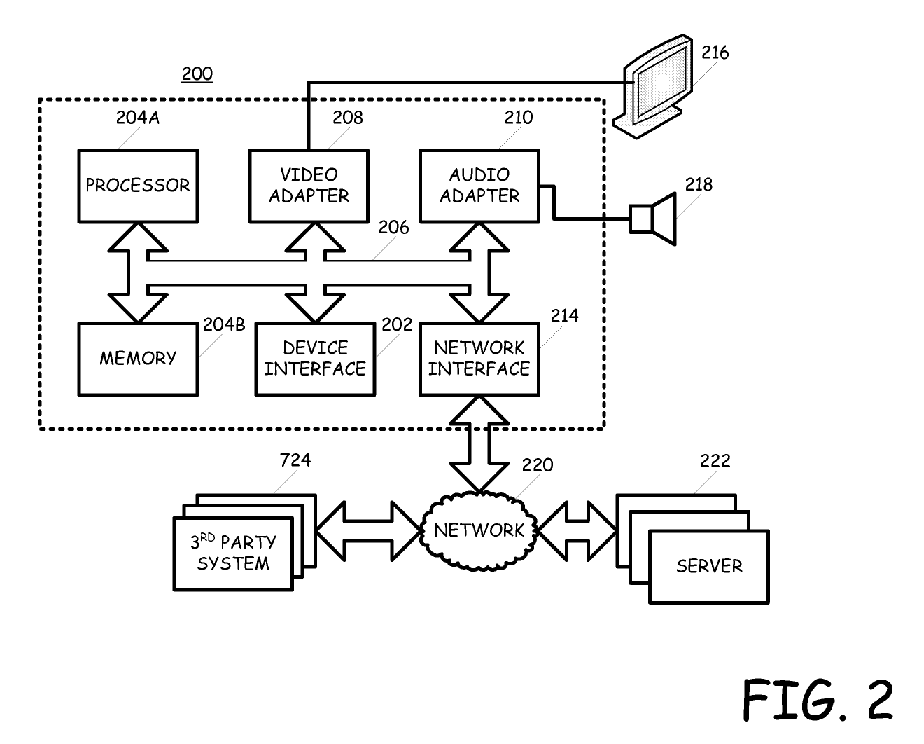

FIG. 2 is a functional block diagram of the components of an exemplary environment, such as a mobile device, suitable for various embodiments of the automatic redialer. It will be appreciated that not all of the components illustrated in FIG. 2 are required in all environments for the automatic redialer but, each of the components are presented and described in conjunction with FIG. 2 to provide a complete and overall understanding of the components of an exemplary environment. The mobile device 200 can include a general computing platform illustrated as including a processor 204A/memory device 204B that may be integrated with each other or, communicatively connected over a bus or similar interface 206. The processor 204A can be a variety of processor types including microprocessors, micro-controllers, programmable arrays, custom IC's etc. and may also include single or multiple processors with or without accelerators or the like. The memory element 204B may include a variety of structures, including but not limited to RAM, ROM, magnetic media, optical media, bubble memory, FLASH memory, EPROM, EEPROM, etc. The processor, or other components may also provide components such as a real-time clock, analog to digital convertors, digital to analog convertors, etc. The processor 204A also interfaces to a variety of elements including a device interface 202, a display adapter 208, audio adapter 210, and a network/device interface 214. The device interface 202 provides an interface to external controls, such as sensors, actuators or the like. The display adapter 208 can be used to drive a variety of display devices, such as an LED display, LCD display, one or more LEDs or other display devices 216. The audio adapter 210 interfaces to and drives an audio device 218, such as a speaker or speaker system, buzzer, bell, etc. The network/device interface 214 may interface to a variety of devices or systems (not shown) such as a cellular communications system, the PSTN, a keyboard, a mouse, a pin pad, and audio activate device, a PS3 or other game controller, as well as a variety of the many other available input and output. The network/device interface 214 can also be used to interface the mobile device 200 to other devices through a network 220. The network may be a local network, a wide area network, wireless network, a cellular network, a global network such as the Internet, or any of a variety of other configurations including hybrids, etc. The network/device interface 214 may be a wired interface or a wireless interface. The mobile device 200 is shown as interfacing to a server 222 and a third party system 224 through the network 220.

As previously described, in some embodiments the automatic redialer may be automatically invoked or initiated as soon as it is loaded into the mobile device or whenever the mobile device is turned on. The automatic redialer can be disabled if for any reason the user wants to turn it off. The automatic redialer can run in the background. Having the automatic redialer run in the background advantageously allows the user to run other applications while the automatic redialer is actively performing the tasks described in FIG. 1 or variants thereof. By having the automatic redialer automatically initiate whenever the application is loaded or whenever the mobile device is turned on ensures that the automatic redialer is always running regardless of whether the user remembers to start the application.

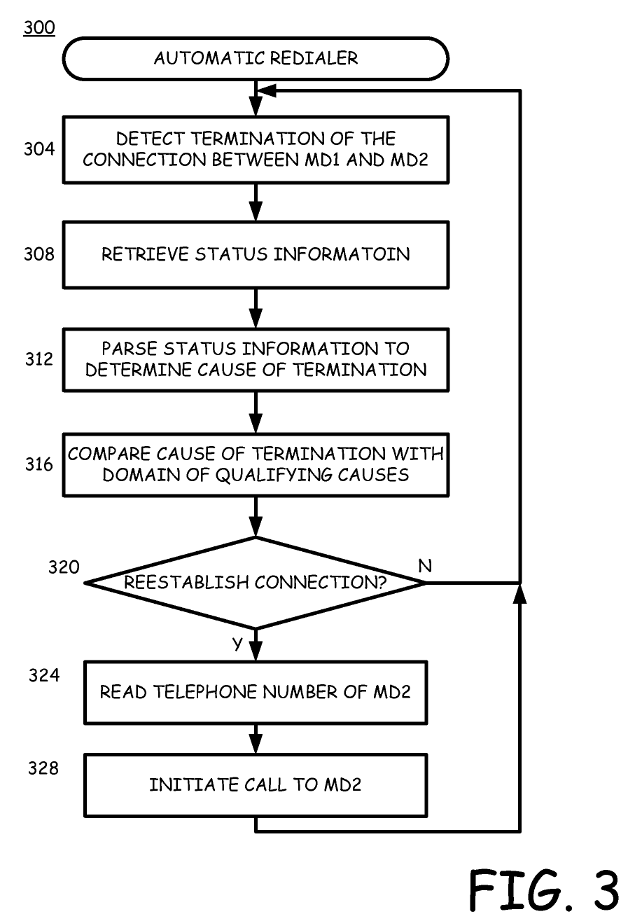

FIG. 3 is a flow diagram illustrating another embodiment of the automatic redialer operating within a mobile device. This embodiment presents exemplary steps involved in a process for recovering from a terminated connection wherein at least a portion of the connection exists over a cellular telecommunications system between a mobile device and at least one other device. In this embodiment, the automatic redialer is embedded within the mobile device but it will be appreciated that the application could have been user loaded or manufacturer loaded. In either case, the mobile device includes an application loaded into a memory element within the mobile device and is operative to provide the automatic redialer functionality.

Initially, the automatic redialer 300 detects a termination of a connection between the mobile device and the at least one other device (MD1 and MD2) 304. The automatic redialer then retrieves status information stored in the memory of the mobile device 308. The status information is data that is created by the mobile device and/or the system and stored into memory of the mobile device and can be described as the “black box” of the mobile device, providing diagnostic information pertaining the operation, failures, etc. of the mobile device.

Once retrieved, the status information can be parsed to identify a cause of termination 312. In addition, other extrinsic or intrinsic data or information may also be used in identifying the cause of the termination. For instance, in some embodiments the automatic dialer may continuously monitor the signal strength and/or signal quality of the connection, monitor the bit error rates detected, monitor the battery level, monitor the physical location of the mobile device by accessing a GPS or other location based device that may be embedded within the mobile device, etc. Once the cause, or causes, of termination is identified, the cause is compared to the domain of qualifying causes 316. For instance, it would not be necessary to reestablish the connection in all situations, especially if the users purposefully terminated the connection because they were done exchanging data. Thus, the domain of qualifying causes is used to define the specific situations in which the automatic redialer will attempt to reestablish a connection. The typical qualifying cause is when the connection is dropped due to poor signal quality or signal degradation. Thus, if the operational state of a mobile device moves from 5 bars, to 2 bars, to 1 bar to NO SERVICE, this information can be used to conclude that the call was dropped due to poor signal quality or, stated otherwise that the signal degradation resulted in the dropped call.

At this point, the automatic dialer must determine if the connection is to be reestablished or not 320. The various embodiments of the automatic dialer can make this determination either by monitoring status of the mobile device, receiving user feedback and/or both. In some embodiments it is important to verify that the current signal conditions for the mobile device are acceptable, or favorable for attempting to reestablish the connection. In such an embodiment, a minimal threshold can be established for the signal quality and, a minimal threshold can be established for the time at which the signal quality must exceed the threshold. Thus, in such an embodiment, unless the signal quality is above the threshold value for a threshold period of time, the automatic redialer will not attempt to reestablish the connection.

In other embodiments, it is important to ensure that the user is aware that an attempt to reestablish the connection is being made and, in some embodiments even requiring the user to allow the reestablishment by requiring the user to actuate a button, soft key or take some other action. As such, in one embodiment an audible alert may be provided to notify the user that the connection is being reestablished. In another embodiment, a visual indicator may be provided. In yet another embodiment, a prompt may be presented to the user either visually and/or audibly requesting the user to take some action to either abort the reconnection and/or allow the reconnection. For instance, the user may be required to press a button, or actuate some other element of a user interface to allow the automatic redialer to continue with attempts to reestablish the connection.

To reestablish the connection, the automatic redialer reads the telephone number associated with the other device (MD2) from the memory element within the mobile device (MD1) 324. An attempt to reestablish a connection between the mobile device (MD1) and the other device (MD2) by is then performed by initiating a call to the read telephone number 328. It should be noted that this step, on some embodiments, only occurs if a match of the cause of termination is identified in the domain of qualifying causes and if the current signal conditions for the mobile device are acceptable.

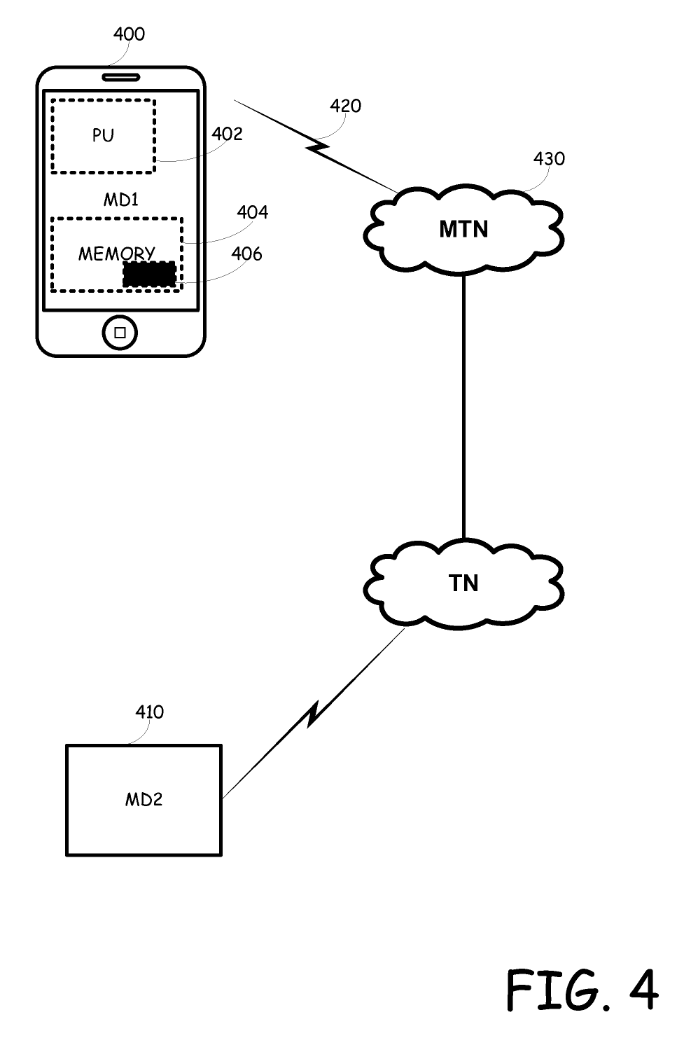

FIG. 4 is a system diagram illustrating the relationship between two components engaged in a connection in which at least a portion of the connection is based on a cellular or mobile telephone network. In the illustrated embodiment, a mobile device MD1 400 is shown as being connected to another device MD2 410 through a telecommunications network in which at least a portion of the connection 420 is based on a cellular mobile network 430.

The mobile device 400 is shown as including a processing unit 402 and a memory element 404. The memory element contains a module or program 406 that defines the operation of the automatic redialer. This embodiment of the automatic redialer may operate by detecting the termination of the connection between the mobile device MD1 400 and the other device MD2 410. In response to such termination, the automatic redialer program 406, under the execution of the processing unit 402, operates to identify the cause of the termination and reestablish the connection between the mobile device and the at least one other device if the cause of termination is a qualifying cause and, reestablishment criteria has been met.

The qualifying causes in such an embodiment may include the loss of signal strength, loss of battery power, and exclude purposeful terminations such as ending the call. Further, the reestablishment criteria may include a stable signal having a minimum signal strength, as well as other factors. To reestablish the connection, the automatic redialer program 406 operates to monitor the received signal strength of the cellular network; and if the received signal strength is above a threshold value for a threshold period of time and the cause of termination is a qualifying cause, reestablishing the connection.

Third Party Application Embodiments and Exemplary Features.

In some embodiments, the automatic redialer may be a function that is built into a mobile device at the time of manufacture or provisioning. However, in some embodiments, the automatic redialer is an application, such as a third party application that can be downloaded over the Internet and then loaded into the mobile device. As a non-limiting example, the automatic redialer could be an application available through the APPLE store to be downloaded to the APPLE Iphone store and then loaded into an IPHONE device. Other mobile devices such as the BLACKBERRY family of devices include a similar capability. In these embodiments, the automatic redialer application then operates as a third party application.

The automatic redialer application, in some embodiments, is able to distinguish between calls that have been terminated by a user hanging up and those that ended by some error condition. The determination will need to occur after the call has terminated and the determination will be based on information available within the mobile device's logs and status reporting mechanisms. Various mechanisms are available on mobile devices, especially mobile telephones that can be used to determine why the last call ended. Status conditions such as signal failure status or network failure are available. In other embodiments, the mobile device can make a query to the network to determine the cause of termination. In yet other embodiments, a combination of both techniques may be used.

Once the automatic redialer application has confirmed that a call was terminated due to an error condition or a qualifying cause, the application will recover the number from the last call. If the last call was initiated by the mobile user then the last number called will be retrieved from the memory of the mobile device. If the last call was an incoming call then the application can retrieve the last number from the incoming call log or other memory element.

Because many dropped calls are due to poor signal quality of network coverage, the automatic redialer application will check the network signal level. Only when a strong and reliable signal has been detected will the application declare it is appropriate to re-initiate the call or reestablish the connection. An algorithm can be used to determine that the signal is likely reliable and will remain strong enough to continue with a call. For instance, in one embodiment the algorithm may monitor the signal strength until a threshold signal strength is met and then, start a timer to ensure that the signal strength remains above the threshold value for a threshold period of time.

Reconnection Notification.

Some embodiments may provide a notification or prompt to the user regarding the automatic redial or reestablishment. After the signal is verified and strong enough to re-initiate the call, or other required criteria is satisfied, in some embodiments the automatic redialer application will operated to notify the mobile device user that the call can be reestablished. This notification is available to ensure the user is prepared and willing to continue with the previous connection. Because the re-initiation of the call must wait for a reliable signal and the time it will take for the mobile device to find a reliable signal is variable, this notification, which can be visual, audible or sensory perceived (such as vibrations, hot spots, etc.) allows the user to continue with other activities until the network is available or the criteria is satisfied.

In one embodiment, following the audible notification the mobile device can present a screen option to the mobile device user to select to continue or to terminate the redial. This option allows the user to terminate the connection should they no longer wish to continue with the previous connection. If the user selects to continue, then the mobile device will immediately dial the retrieved number. If the user chooses to not reestablish the connection, then the process is ended and no call will be initiated. However, if the user takes no action, the reestablish process can continue in just a few seconds.

Collision Resolution

In some situations, two devices connected over the network may both include embodiments of the automatic redialer. In such a situation, it is possible that when the call is dropped, both mobile devices begin to reestablish the connection. This action could result in a collision in which neither device is available to reestablish the connection and as such, even if a connection could be established in this case, no connection would be established. These collisions can be resolved in a variety of manners and, a few non-limiting examples are provided. In one embodiment, a random number generator or pseudo random number generator is used to generate a number that defines a delay that must occur prior to attempting to reestablish the connection. This technique greatly reduces the probability of a collision. In yet another embodiment, the telephone number of the mobile device to be called may be used to generate a delay value.

In another embodiment, if a mobile device detects that an incoming call is being received while attempting to reestablish the connection, the mobile device can examine the caller id of the incoming call and, if it matches the desired connection, the mobile device can abort the reestablishment process and simply answer the incoming call.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method for reestablishing connections within a cellular telecommunications system, the method comprising the steps of:
loading an application into the memory of a mobile device, the application including instructions that can be executed by a processor;
the application detecting a terminated connection between the mobile device and at least one other device; and
if the application determines that the detected termination is a qualifying cause, attempting to reestablish the connection between the mobile device and the at least one other device.

2. The method of claim 1, wherein the step of attempting to reestablish the connection further comprises:
extracting from the memory of the mobile device a telephone number associated with the at least one other device; and
initiating a call to the at least one other device using the extracted telephone number.

3. The method of claim 2, wherein the extracted telephone number is a last dialed telephone number.

4. The method of claim 2, wherein the extracted telephone number is the caller ID of the at least one other device.

5. The method of claim 1, wherein prior to the step of attempting to reestablish the connection, the method comprises the step of verifying that required criteria for reestablishing the connection are met.

6. The method of claim 5, wherein the step of verifying that the required criteria are met further comprise determining that the received signal strength is above a minimal value.

7. The method of claim 5, wherein subsequent to the step of verifying that the required criteria are met and prior to the step of attempting to reestablish the connection, the method comprise the step of providing a notification that the connection can be reestablished.

8. The method of claim 7, wherein subsequent to the step of providing a notification and prior to the step of attempting to reestablish the connection, the method further comprises the step of receiving an actuation indicating that the step of attempting to reestablish the connection can continue.

9. A mobile device that operates within a cellular telecommunications system to reestablish dropped connections, the mobile device comprising:
a processing unit;
a memory element communicatively coupled to the processing unit;
a module stored in the memory element and including instructions that when executed by the processing unit performs the steps of:
detecting the termination of a connection between the mobile device and at least one other device, wherein the connection is based at least in part on a cellular telecommunications network;
identifying the cause of the termination; and
reestablishing the connection between the mobile device and the at least one other device if the cause of termination is a qualifying cause and, reestablishment criteria has been met.

10. The mobile device of claim 9, wherein a qualifying cause includes a loss of signal strength.

11. The mobile device of claim 9, wherein a qualifying cause excludes a user actuation to end the connection.

12. The mobile device of claim 9, wherein the reestablishment criteria includes a stable signal having a minimum signal strength.

13. The mobile device of claim 9, wherein the step of reestablishing the connection if reestablishment criteria has been met further comprises:
monitoring the received signal strength of the cellular network; and
if the received signal strength is above a threshold value for a threshold period of time and the cause of termination is a qualifying cause, reestablishing the connection.

14. The mobile device of claim 9, wherein the step of reestablishing the connection if reestablishment criteria has been met further comprises verifying that a call is not currently in process on the mobile device.

15. The mobile device of claim 9, wherein a qualifying cause includes a loss of signal strength.

16. The mobile device of claim 9, wherein a qualifying cause excludes a user actuation to end the connection.

17. The mobile device of claim 9, wherein prior to reestablishing the connection, further comprising providing an audible notification to alert that an attempt to reestablish the connection is eminent.

18. The mobile device of claim 9, wherein prior to reestablishing the connection, further comprising providing a prompt to solicit a user actuation of acceptance.

19. A method for recovering from a terminated connection wherein at least a portion of the connection exists over a cellular telecommunications system between a mobile device and at least one other device, the mobile device including an application loaded into a memory element within the mobile device, which when executed by a processing unit of the mobile device performs the method comprising the steps of:
detecting a termination of a connection between the mobile device and the at least one other device;
retrieving status information from the memory element within the mobile device;
parsing the status information to identify a cause of termination;
comparing the cause of termination with a domain of qualifying causes of termination;
determining if the current signal conditions for the mobile device are acceptable;
reading the telephone number associated with the at least one other device from the memory element within the mobile device;
attempting to establish a connection between the mobile device and the at least one other device by initiating a call to the read telephone number if a match of the cause of termination is identified in the domain of qualifying causes and if the current signal conditions for the mobile device are acceptable.

20. The method of claim 18, wherein the domain of qualifying causes includes a degradation in signal quality and, the step of determining if the current signal conditions for the mobile device are acceptable comprises determining if the signal quality is above a minimal threshold value.

21. The method of claim 19, wherein prior to the step of attempting to establish a connection, the method further comprises the step of:
providing an notification indicator to a user of the mobile device, the notification indicator signaling that attempts to establish the connection are pending; and
receiving a user actuation of the mobile device, the user actuation signaling that the connection to establish the connection should not be conducted.
